(19) United States
(12) Patent Application Publication
(10) Pub. No.: US 2025/0091573 A1
(43) Pub. Date: Mar. 20, 2025

(54) VALIDATING A TRAVEL CORRIDOR FOR LATERAL GUIDANCE OF A MOTOR VEHICLE

(71) Applicants: CARIAD SE, Wolfsburg (DE); VOLKSWAGEN AKTIENGESELLSCHAFT, Wolfsburg (DE)

(72) Inventors: Michael Stark, Berlin (DE); Daniel Münning, Braunschweig (DE)

(21) Appl. No.: 18/885,279

(22) Filed: Sep. 13, 2024

(30) Foreign Application Priority Data
Sep. 14, 2023 (DE) 10 2023 124 799.9

(51) Int. Cl. B60W 30/12; B60W 40/02

(52) U.S. Cl. CPC B60W 30/12; B60W 40/02

(57) ABSTRACT

The disclosure relates to validation of a driving corridor for lateral guidance of a motor vehicle by a driver assistance system. Based on environmental data, a driving corridor with corridor boundaries is determined, the corridor boundaries specifying a first track width for the lateral guidance of the motor vehicle. It is then checked whether there is more than one driving trajectory within the corridor boundaries, by determining whether there is more than one data point along a rear axle of the motor vehicle, each of which is assigned to a different driving trajectory. Based on a result of the determining, the driving corridor is validated and the first track width is used for the lateral guidance of the motor vehicle, or the driving corridor is falsified and a different, second track width is used for the lateral guidance of the motor vehicle.

### BACKGROUND

### Technical Field

The disclosure relates to a method for validating a driving corridor for lateral guidance of a motor vehicle by a driver assistance system. The disclosure also relates to a driver assistance system for lateral guidance of a motor vehicle. The driver assistance system can be used, for example, to carry out the described method for validating the driving corridor. Finally, the disclosure also relates to a motor vehicle with a corresponding driver assistance system.

### Description of the Related Art

In modern motor vehicles, driver assistance systems are used to support the driver in a driving task and/or to take over the guidance or control of a motor vehicle completely or partially instead of the driver. For example, there are lateral driver assistance systems that automatically control the steering of the vehicle. To do this, the driver assistance system uses environmental data that represents the vehicle's surroundings. The environmental data is available in the form of sensor data, for example. It can, for example, be recorded by a camera or another environmental sensor of the motor vehicle. Additionally or alternatively, the environmental data may be available in the form of swarm data. Swarm data is a collected data set that a swarm of vehicles has compiled from a large number of vehicles for a specific route or route network. In addition to the representation of the environment for the respective route or route network, the swarm data can contain vehicle data for each or the community of participating (swarm) vehicles. The vehicle data includes, for example, a swarm trajectory of the swarm of vehicles.

The driver assistance system can evaluate or process this environmental data in order to implement the desired assistance function. For lateral guidance, for example, the driver assistance system can determine a driving corridor or a resulting lane width from the environmental data. For this purpose, the driver assistance system can extract lane boundaries, such as a lane marking or a lane edge, from the environmental data. A driving trajectory for the vehicle (ego trajectory) can be calculated based on the lane boundaries. Alternatively, it is possible, for example, to use the swarm trajectory as the driving trajectory. The driving trajectory is used during lateral guidance to steer the vehicle within the specified lane width.

The use of environmental data for the automatic lateral guidance of a motor vehicle is known from the state of the art.

For example, DE 10 2021 205 669 B3 discloses a driver assistance system that uses swarm data for lateral guidance. Support points are selected from the swarm data, converted into a data format for the driver assistance system that can be used for lateral guidance and then used for lateral guidance. The support points are selected depending on the driving situation.

US 2017/0123434 A1 discloses a driver assistance system with which a travel plan for a driver assistance system is determined. The travel plan contains a target route from a current position to a final position which the vehicle is to follow. In addition to longitudinal positions, the target route also contains lateral positions in relation to the lane width of a roadway.

It is possible that the detected lane corridor is not used by the vehicle alone, but also by other traffic or oncoming traffic, for example. For example, there are rural roads without center lane markings where the lane edges could be assumed to be the lane width for the cross traffic. Therefore, in such situations, regardless of whether other vehicles are actually using the corridor, the lane width is restricted for cross traffic. For example, a very narrow lane width is defined, which can be adapted to the dimensions of a motor vehicle in particular. Such a narrow track width can significantly reduce driving comfort for a vehicle occupant. For example, when cornering, the driver assistance system may steer the curve particularly tightly due to the narrow track width. In addition, the driver assistance system may restrict and/or block steering interventions by a driver at an early stage, for example because the driver assistance system is set to the narrow or small track width.

### BRIEF SUMMARY

Embodiments of present disclosure determine a track width for lateral guidance of a motor vehicle in accordance with a situation.

The disclosure is based on the realization that the actual corridor occupancy should be taken into account when determining the lane width. In addition to the ego trajectory, additional driving trajectories (external trajectories) of other motor vehicles (external vehicles) can be taken into account. The external trajectories provide information as to whether there is, for example, shared traffic or oncoming traffic within the driving corridor under consideration. This makes it possible to validate or reject a driving corridor and the associated lane width determined from the lane markings, for example, and to use a different lane width.

However, the proposed trajectory determination is subject to the limitation that current driver assistance systems generally do not have sufficient computing resources or computing power to record and evaluate several driving trajectories in a driving corridor. So far, known driver assistance systems have therefore only ever evaluated one trajectory within a driving corridor. It is therefore proposed to consider only individual data points or coordinate points of each trajectory instead of the entire driving trajectories for the validation of the driving corridor.

According to one aspect, the disclosure proposes a method for validating a driving corridor for lateral guidance of a motor vehicle by a driver assistance system. A driving corridor with corridor boundaries is determined as a function of environmental data of an environment of the motor vehicle. The corridor limits specify a first track width for the lateral guidance of the vehicle. The corridor boundaries thus limit a movement space for the motor vehicle lateral to its direction of travel. They can therefore specify a maximum possible track width for the lateral movement of the vehicle within the travel corridor.

The system then checks whether more than one driving trajectory, i.e., more than one drivable path, is provided within the corridor boundaries. To conserve resources, it is determined whether there is one or more than one data point or coordinate point along a specified lateral axis, such as a rear axle of the vehicle, relative to its direction of travel, with each data point being assigned to exactly one different driving trajectory. In particular, the data point specifies geocoordinates (geographical coordinates) of the assigned driving trajectory at its interface with the lateral axis.

Depending on the result of the check, the determined driving corridor is then validated or confirmed as being permissible. Validation means that the first track width specified by the corridor limits can be used for the lateral guidance of the motor vehicle and is particularly used. Validation can thus be used to specify or determine that the driving corridor belongs only to the motor vehicle, which is also referred to below as the ego vehicle. In particular, the ego vehicle does not need to share the driving corridor with other vehicles, i.e., external vehicles. This means that the maximum lane width permitted by the driving corridor can be selected as the permitted lane width for lateral guidance.

This means that the driving paths of other vehicles are also taken into account when evaluating the driving corridor. As a result, the lane width for the vehicle can be determined depending on the respective driving situation in the surroundings. Unnecessary interventions in the steering by the driver assistance system or particularly tight bends can thus be avoided, improving driving comfort for the occupants. The use of data points instead of entire chains of points for a driving trajectory can also improve the use of resources when checking the driving trajectory.

In the present case, a driver assistance system refers in particular to an electronic vehicle guidance system. This means that the driver assistance system is preferably set up to guide the (motor) vehicle fully automatically or semi-automatically, in particular without the need for intervention by a driver. Preferably, the present driver assistance system is designed to control the motor vehicle in accordance with SAE levels 1 to 4, which classify predefined automation levels for driver assistance systems in accordance with SAE standard J3016.

The (semi-)automatic control system ensures that the vehicle automatically performs all necessary functions, such as steering, braking and acceleration maneuvers, the observation and detection of the vehicle's surroundings, such as road traffic, and the corresponding reactions. Depending on the desired assistance function, a distinction can be made between longitudinal and lateral driver assistance systems. Alternatively, a driver assistance system with combined functionality is conceivable, for example. Braking or acceleration maneuvers, i.e., driving maneuvers that affect the vehicle drive, are implemented by a longitudinal driver assistance system, for example. Steering maneuvers, i.e., driving maneuvers that affect the vehicle steering, are implemented by a lateral driver assistance system, for example. To perform the respective driving maneuver, the driver assistance system can provide a corresponding control signal to one or more actuators of the motor vehicle. For example, the driver assistance system can control one or more brake actuators and/or one or more steering actuators and/or one or more drive motors of the motor vehicle. Lateral control is particularly relevant for vehicle control within the specified track width.

The driver assistance system uses the environmental data to monitor the surroundings. The environmental data is, for example, sensor data from one or more of the vehicle's environmental sensors and/or swarm data that is provided, for example, by a backend server external to the vehicle. As an environment sensor, the motor vehicle can, for example, include one or more cameras or one or more radar sensors. These can record or capture an image or representation of the surroundings and transmit the resulting sensor data to the driver assistance system for evaluation.

The swarm data can, for example, be data that is stored in a so-called roadbook in the backend server. The roadbook can be understood as an extended digital road network map or roadway network map. The roadbook can therefore include a digital representation of the surroundings. For this purpose, sensor data describing the surroundings, which was recorded or determined by a large number of vehicles in a vehicle swarm or a vehicle fleet during the journey, can be compiled or collected. The extension can be that a data collection of driving data of the vehicles is also included. The driving data includes, for example, vehicle settings and/or a driving history of the respective vehicle. The driving history can include a driving trajectory that indicates, for example, the direction of travel and speed of the respective vehicle. The collection of driving data and/or sensor data of all swarm vehicles for each route section in the road network map is referred to as swarm data. This swarm data can be transmitted from the backend server to the driver assistance system for evaluation.

The driver assistance system can receive and evaluate or process the environmental data, i.e., the swarm data and/or sensor data. In particular, this involves extracting the driving corridor with the corridor boundaries for the respective route section on which the vehicle is currently located, for example, from the environmental data. The data is extracted using known analysis methods, such as an object recognition algorithm.

The corridor boundaries can be indicated by lane boundaries, for example. The lane boundaries can be, for example, linear elements such as lane markings, a lane edge and/or structural elements such as curbs. The driver assistance system can now use the corridor boundaries to determine or calculate the first lane width. The corridor boundaries form the limit of the first lane width. Alternatively, depending on the corridor boundaries, virtual boundaries can be defined for the first lane width, for example, which therefore lies within the corridor boundaries.

One or more driving trajectories can also be extracted from the environment data, in particular the swarm data, provided that they are available for the respective route section on which the ego vehicle is currently located. The driving trajectories can include, for example, an ego trajectory of the ego vehicle and/or one or more external trajectories of external vehicles.

The respective driving trajectory is provided or determined in particular as a chain of points, i.e., as a sequence of several data points or coordinate points. Preferably, the respective driving trajectory is converted to a coordinate system in relation to the ego vehicle. For example, this can be a two-dimensional x-y coordinate system in which “x” indicates the direction of travel or longitudinal axis of the vehicle and “y” indicates the lateral direction or lateral axis of the vehicle. The origin of the coordinates (x=0, y=0) is used in particular as a point of intersection of the center axis of the ego vehicle in the longitudinal direction (longitudinal axis) and the rear axis (lateral axis) of the motor vehicle. Based on the current position of the motor vehicle, an x and y value can thus be specified for each data point of each of the driving trajectories, which indicates the position of the data point for each driving trajectory relative to the ego vehicle.

In the present case, only one such data point of each trajectory is used to evaluate the driving trajectories. Preferably, the data point that lies on the rear axle, i.e., the y-axis, is selected. It is therefore not necessary to evaluate the entire chain of points of a driving trajectory. Depending on how many of the data points under consideration lie within the corridor limits, the determined driving corridor, in particular the first track width, is validated (confirmed) or falsified (rejected). In response to the validation, the first track width is used for the lateral guidance. This means that the first lane width can be used as a control parameter in a control system of the driver assistance system for lateral guidance. In response to the falsification, however, the first track width is not used for lateral guidance. Instead, for example, as described in more detail below, a different track width is determined and used.

Using the respective lane width means, for example, that the area defined by the lane width is available for lateral guidance maneuvers, such as steering the vehicle, without leaving the driving corridor or the lane width. The lane width is limited, for example, by virtual lane boundaries or real lane boundaries, such as the corridor boundaries in the lateral direction to the vehicle. If the lateral guidance is to include a lane change maneuver, for example, this should be indicated separately, for example by a direction indicator (turn signal) of the ego vehicle.

In other words, the method described is intended to evaluate the driving corridor for automated lateral guidance. Environmental data, preferably swarm data, is used for this purpose. The swarm data can be used to assess whether the driving corridor is only used by the ego vehicle or whether, for example, oncoming traffic or other traffic, such as vehicles driving alongside the ego vehicle, also use this corridor. The permissible permitted lane width of the driving corridor is preferably set using the swarm data, thus validating the lane width.

The disclosure includes embodiments that provide additional advantages.

According to one embodiment, the determined driving corridor is only validated if exactly one data point is determined within the driving corridor according to the check. Preferably, this data point belongs to the ego trajectory of the motor vehicle. In other words, the first track width is only used for lateral guidance if only the ego trajectory, i.e., the trajectory that the ego vehicle is currently following, is present within the driving corridor. This means that there are no other driving trajectories, for example from other vehicles, within the driving corridor. This ensures that only the ego vehicle is moving within the driving corridor and that there is no oncoming traffic, for example.

Preferably, in addition to the exact one data point, further route information on the driving corridor for the current route section on which the vehicle is currently located is available from the environment data, in particular the swarm data. The additional route information can be, for example, lane markings or objects in the vicinity of the respective route section. This ensures that the first lane width is only used if the current route section is contained in the swarm data and is therefore known.

According to one embodiment, the determined driving corridor is falsified, i.e., not validated, as a function of a result of the check if at least two data points are determined within the driving corridor according to the check. The falsification includes that a second track width different from the first track width is defined and used for the lateral guidance of the motor vehicle. In particular, the second track width has different dimensions to the first track width. Preferably, the second track width is narrower in the lateral direction than the first track width. For example, it can be taken into account if there are several different driving trajectories within the driving corridor, which represent, for example, co-traffic or oncoming traffic for the motor vehicle. The driving corridor therefore does not belong to the ego vehicle alone. The lane width should then be adjusted.

According to one embodiment, a data point spacing of the at least two data points along the lateral axis of the motor vehicle is determined to determine the second track width. The second of the track widths is defined or determined as a function of the data point spacing. In other words, the distance of track limits, which limit or restrict the second track width, can be set depending on the distance between the data points. Preferably, the lane width is selected in such a way that two vehicles can drive next to each other or past each other in the travel corridor with sufficient distance to each other in co- or oncoming traffic.

To determine the distance of the data points relative to the ego vehicle, for example, the position of the data point assigned to the ego trajectory of the vehicle can be used as the coordinate origin (x=0, y=0). The distance between one or more of the two data points of driving trajectories can then be determined along the lateral axis, i.e., in the y-direction. For example, the difference of the y-values between the data points of the ego trajectory and the other trajectory is calculated. Based on this, the permissible track width for the ego vehicle can then be determined.

According to one embodiment, the second track width is narrower than the first track width. This means that the distance between the track boundaries of the first track width is greater than the distance between the track boundaries of the second track width. The narrower second track width can have a width of 4 to 6 m, for example. The wider first track width can have a width of more than 6 m, for example.

According to one embodiment, a value of the respective track width is predetermined in accordance with a predetermined selection criterion as a function of a parameter of at least two driving trajectories within the driving corridor or as a function of a parameter of the driving corridor. This means that the value of the first and/or second track width can preferably be applied freely, taking the parameter into account. For example, the respective track width value can be stored in a characteristic map or in a characteristic curve as a function of the respective parameter. The parameter can be, for example, a curvature of the driving corridor and/or the aforementioned distance of the data points along the lateral axis and/or a distance of the corridor boundaries and/or a dimensioning of the motor vehicle and/or a predetermined standard dimension for motor vehicles.

This means that the dimension of the respective track width is preferably determined or adapted depending on the curvature of the travel corridor. For example, the track width can be dimensioned more generously for sections with bends than for straight sections. If the roadway curves with a radius of 50 to 100 m, the narrow second track width can be 6 m, for example. The wider first track width can be an additional 1 m or more, for example 7 or 8 m.

Additionally or alternatively, the dimension of the ego vehicle can be taken into account when determining the second track width. This means, for example, that the second track width can be selected to be just as wide as is permitted, for example, by standards or specifications in road traffic depending on standardized vehicle dimensions (standard dimension).

Preferably, a distinction can be made between at least three track widths. The first track width can, for example, correspond to the width of the travel corridor. The second track width can, for example, be narrower than the travel corridor and can, for example, be determined as a function of the data point spacing. A third lane width can be narrower than the first and second lane widths and can, for example, be selected depending on the vehicle dimensions.

According to one embodiment, the respective data point comprises information for a permitted direction of travel along the assigned driving trajectory. The second lane width is additionally determined depending on the included direction of travel relative to a direction of travel of the motor vehicle. In other words, the direction of travel, i.e., the assignment of the respective driving trajectory to the vehicle's co-traffic or oncoming traffic, is taken into account when calculating the second lane width. For example, the second lane width can be narrower for the respective travel corridor with the same direction of travel (co-traffic) than with the opposite direction of travel (oncoming traffic) or vice versa.

According to one embodiment, the respective driving trajectory or each additional driving trajectory to a driving trajectory of the motor vehicle is determined from swarm data, whereby the swarm data contains, as the respective additional driving trajectory, an external trajectory of at least one external vehicle which has already driven through the respective driving corridor. This means that the swarm data mentioned at the beginning is used as the surrounding data. The ego trajectory of the vehicle is particularly preferably determined from the aforementioned sensor data. Preferably, only the respective further driving trajectory is determined from the swarm data, if this is available.

For use cases or use situations which may arise during the method and which are not explicitly described here, it may be provided that an error message and/or a request for user feedback is output and/or a default setting and/or a predetermined initial state is set in accordance with the method.

According to one aspect, the disclosure relates to a driver assistance system for lateral guidance of a motor vehicle. The driver assistance system is designed to determine a driving corridor with corridor boundaries as a function of environmental data in an environment of the motor vehicle. These corridor limits specify a first lane width for the lateral guidance of the motor vehicle. Furthermore, the driver assistance system is designed to check whether more than one driving trajectory is provided within the corridor boundaries and, for this purpose, to determine whether there is more than one data point along a predefined lateral axis of the motor vehicle relative to its direction of travel, each of which is assigned to a different driving trajectory and specifies at least geocoordinates of the assigned driving trajectory. Depending on the result of the check, the driver assistance system is designed to validate the driving corridor. The validation comprises the use of the first track width specified by the corridor boundaries for the lateral guidance of the motor vehicle.

The driver assistance system can therefore carry out or perform a procedure as described above. For this purpose, the driver assistance system may, for example, have a control device. The control device can have a data processing device or a processor device which is set up to carry out an embodiment of the method according to the. For this purpose, the processor device may comprise at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as the microprocessor. Furthermore, the processor device can have program code which is set up to carry out the embodiment of the method according to the disclosure when executed by the processor device. The program code may be stored in a data memory of the processor device. The processor device may, for example, be based on at least one circuit board and/or on at least one SoC (System on Chip).

According to one aspect, the disclosure relates to a motor vehicle with a driver assistance system as described above by way of example. The motor vehicle is preferably designed as a motor vehicle, in particular as a passenger car or truck or as a passenger bus or motorcycle. The motor vehicle can preferably have a steering system or a steering gear for moving the lateral guidance. The steering system can be controlled for lateral guidance by means of the driver assistance system.

The disclosure also includes further embodiments of the driver assistance system according to the disclosure and of the motor vehicle according to the, which have features as already described in connection with the further embodiments of the method according to the. For this reason, the corresponding further embodiments of the driver assistance system according to the disclosure and of the motor vehicle according to the disclosure are not described again.

The disclosure also includes combinations of the features of the embodiments described. The disclosure thus also includes implementations which each have a combination of the features of several of the embodiments described, provided that the embodiments have not been described as mutually exclusive.

### BRIEF DESCRIPTION OF THE SEVERAL VIEWS OF THE DRAWINGS

Examples of embodiments of the disclosure are described below.

FIG. 1 is a schematic representation of a motor vehicle with a driver assistance system for lateral guidance of the motor vehicle;

FIG. 2 is a schematic process flow diagram for a method for operating the driver assistance system according to FIG. 1 according to one embodiment; and

FIG. 3 is a schematic process flow diagram for a method for operating the driver assistance system according to FIG. 1 according to a further embodiment example.

### DETAILED DESCRIPTION

The embodiments described below are advantageous embodiments of the disclosure. In the embodiment examples, the described components of the embodiments each represent individual features of the disclosure which are to be considered independently of each other and which also further form the disclosure independently of each other. Therefore, the disclosure is also intended to include combinations of the features of the embodiments other than those shown. Furthermore, the described embodiments can also be supplemented by further features of the disclosure already described.

In the figures, identical reference signs denote elements with the same function.

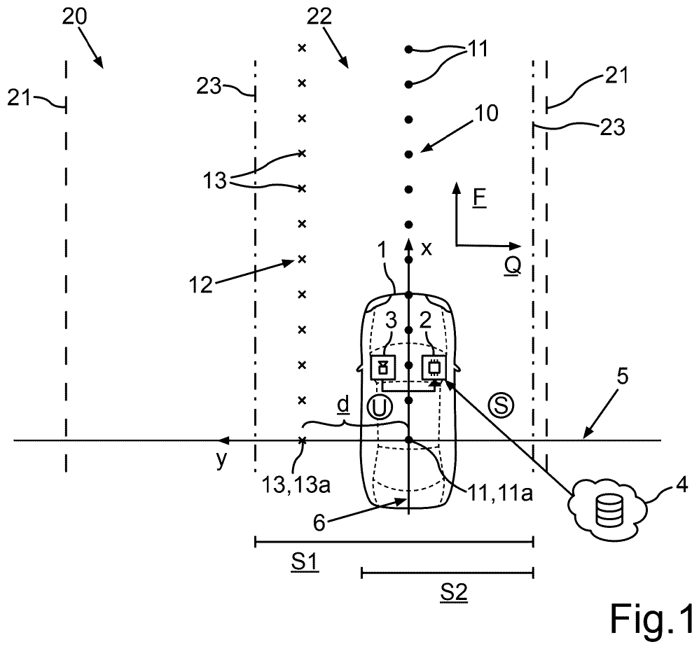

FIG. 1 shows a highly simplified schematic representation of a motor vehicle 1 from a top view or bird's eye view. The motor vehicle 1 is, for example, a passenger car.

FIG. 1 shows the motor vehicle 1 in a driving mode, i.e., while driving. Here, the motor vehicle 1 moves along a predetermined direction of travel F on a roadway 20. In particular, FIG. 1 shows a section of a route that the motor vehicle 1 is currently following along the roadway 20. The roadway 20 may, for example, be a road or another type of surface that is approved for motor vehicle traffic. Lateral to the direction of travel F, the roadway 20 is bounded by two roadway boundaries 21. The lane boundaries 21 may, for example, be lane markings or a lane edge. Outside the lane boundaries 21, it is no longer possible or permitted for the vehicle 1 to drive on the ground.

Driving is to be automated. For this purpose, the motor vehicle 1 comprises a driver assistance system 2. The driver assistance system 2 can be a so-called travel assist, for example. Automatic means, in particular, that no intervention in the controls by the driver is required. The driver assistance system 2 automatically initiates all necessary functions, such as longitudinal and lateral guidance maneuvers, observations of the surroundings to detect road traffic and corresponding reactions. The longitudinal guidance maneuvers are, in particular, driving maneuvers in the direction of travel F of the motor vehicle 1. These include, for example, braking and acceleration maneuvers. The lateral guidance maneuvers are in particular driving maneuvers or lateral to the direction of travel F, i.e., in the lateral direction Q. This includes, for example, steering maneuvers. In order to implement the functions required for vehicle guidance, the driver assistance system 2 can, for example, provide a suitable control signal to one or more actuators of the motor vehicle 1. For lateral guidance, for example, a control signal can be sent to a steering actuator or a steering system of the motor vehicle 1. For longitudinal guidance, for example, a brake actuator or one or more drive motors of the motor vehicle 1 can be controlled with a corresponding control signal.

In connection with the embodiment examples in the figures, the following refers in particular to the lateral guidance of the motor vehicle 1. The lateral guidance involves controlling the motor vehicle 1 within a predetermined driving corridor 22. The motor vehicle 1 is to be kept stable within corridor limits 23 of the driving corridor 22, in particular as long as no lane change maneuver, such as a turn, lane change or overtaking, is to be carried out by the motor vehicle 1. The corridor limits 23 can therefore be used to specify a maximum lane width for lateral guidance. In the present embodiment example, for example, a driving corridor 22 is shown which is narrower or less wide (in the lateral direction Q) than the roadway 20. Only part of the roadway 20 is therefore available to the motor vehicle 1 for automatic guidance.

Conventional lateral driver assistance systems implement a so-called center guidance for lateral guidance. This means that the motor vehicle 1 is preferably controlled within the driving corridor 22 in such a way that the motor vehicle 1 moves centrally between the corridor boundaries 23. FIG. 1 shows, for example, a driving trajectory 10 for the motor vehicle 1 that takes such center guidance into account.

In order to implement center guidance, the driver assistance system 2 must be aware of the surroundings of the motor vehicle 1, in particular the driving corridor 22 with the corridor boundaries 23. To detect the environment, the motor vehicle 1 therefore comprises an environment detection device with one or more environment sensors. In the present case, an environment sensor is designed as a camera 3, for example. As an alternative to the camera 3, the motor vehicle 1 can, for example, have one or more radar sensors or another known type of environment sensor for environment detection.

In FIG. 1, for example, the camera 3 is attached to the motor vehicle 1 in such a way that the camera 3 can record or capture the environment in front of the motor vehicle 1 in the direction of travel F. The camera 3 can provide environment data U, which can contain one or more images of the environment, to the driver assistance system 2, in particular a control device or data processing device of the driver assistance system 2, for processing. The driver assistance system 2 can evaluate the environment data U according to known methods and thus, for example, extract environment features or objects as environment data U. For this purpose, the driver assistance system 2 can, for example, execute or perform an object recognition algorithm.

The environmental features can include, for example, the lane boundaries 21, which in this case form the corridor boundaries 23 for the driving corridor 22. Using the corridor boundaries 23 as orientation aids or support points, the driver assistance system 2 can now calculate the driving trajectory 10 for center guidance. The trajectory is calculated using known methods. For example, the distance between the corridor boundaries 23 is used as the first lane width S1, and thus the maximum available lane width, in order to implement the driving trajectory 10 for center guidance based on this. In connection with the lateral guidance, the driver assistance system 2 is designed to adjust the motor vehicle 1 to this trajectory 10. For this purpose, the driver assistance system 2 can, for example, control the steering of the motor vehicle 1.

To ensure that the driving trajectory 10 is available in a meaningful data format for fast and effective processing by the driver assistance system 2, the trajectory 10 is usually used as a chain of points consisting of a large number of data points 11. The data points 11 are geographical coordinates that form target points for controlling the motor vehicle 1 in the direction of travel Fin front of the motor vehicle 1. For the sake of clarity, only some of the data points 11 are marked with a corresponding reference sign in FIG. 1.

The calculation of the trajectory 10 is based on a predetermined reference system or reference point of the motor vehicle 1. In FIG. 1, a reference system is selected as an example, which takes into account a predetermined lateral axis, in this case the rear axles 5, and the longitudinal axis 6 of the motor vehicle 1 in the direction of travel F. The point at which the rear axle 5 and the longitudinal axle 6 of the motor vehicle 1 intersect is used as the origin of the reference system. FIG. 1 shows a two-dimensional x-y coordinate system as the reference system. The x-axis of the coordinate system runs along the longitudinal axis 6, while the y-axis of the coordinate system runs along the lateral axis 5. For the driving trajectory 10, the data points 11 therefore only have x values. The y-values are set to zero.

In certain situations, the detected travel corridor 22 may not be available for vehicle 1 alone. For example, it may be the case that vehicle 1 has to share the driving corridor 22 with other traffic or oncoming traffic. One example of this is suburban country roads where there are only the lane boundaries 21 and no center lane markings. Another example is inner-city roads where there are no edge markings and, for example, only a center lane marking.

In conventional lateral driver assistance systems, a much narrower track width is therefore used for center guidance instead of the first track width S1, which is specified by the corridor boundaries 23, for example. The narrower track width is adapted to the dimensions of the motor vehicle 1, for example, and in particular is independent of the first track width S1. As a result, when cornering with the motor vehicle 1, the bend is taken very tightly, which can be uncomfortable for vehicle occupants.

In the present case, the first track width S1 can be 8 m, for example. The motor vehicle 1 can be 2 m wide along the lateral axis 5, for example. A track width of 4 m, for example, is used as a narrower track width.

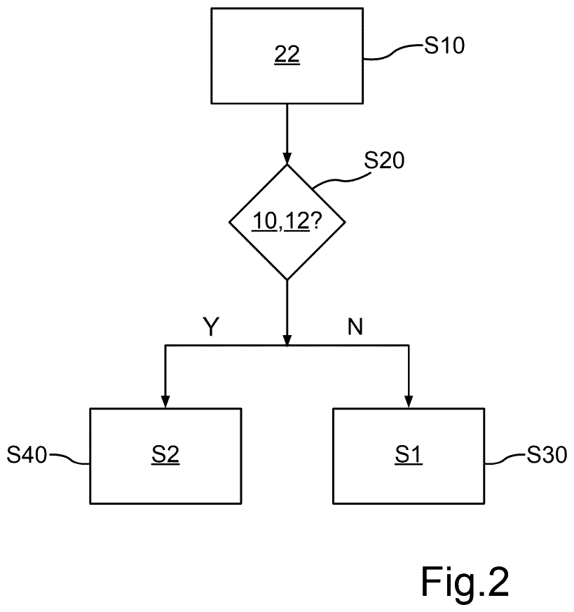

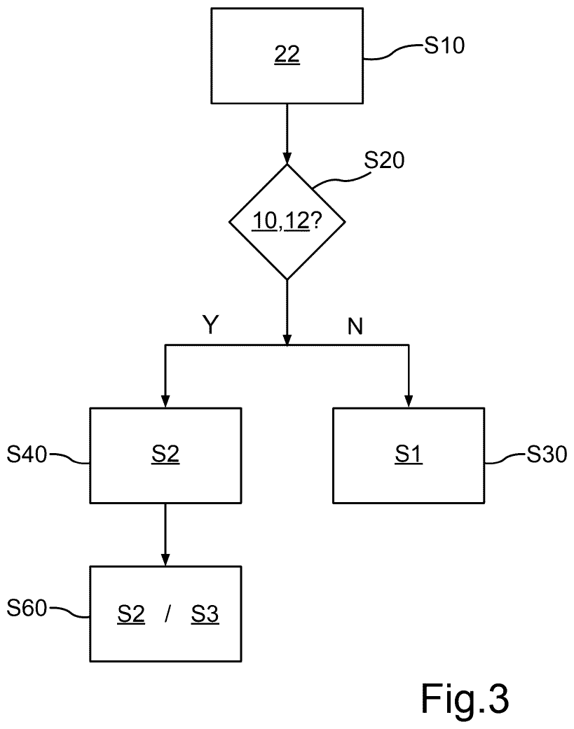

In order to avoid unnecessary restrictions for automatic driving, the idea is to determine a maximum permitted track width. Instead of storing maximum lane widths in the calculation model for lateral guidance as before, these are taken into account depending on the actual surrounding situation. The aim is therefore to determine whether a driving corridor ahead belongs to the vehicle alone and whether this driving corridor, in particular the associated lane width S1, can be used for center guidance. In other words, the driving corridor 22, in particular the associated lane width S1, is to be either validated or falsified (rejected) depending on the surrounding situation, in particular the traffic situation in the driving corridor 22. Examples of specific methods of how the validation of the travel corridor 22, in particular lane width S1, can be implemented are described in more detail later with reference to FIG. 2 and FIG. 3.

For this purpose, the driver assistance system 2 checks whether there is at least one further driving trajectory, also referred to below as an external trajectory, within the driving corridor 22 in addition to the driving trajectory 10, which is also referred to below as the ego trajectory of the motor vehicle 1. In FIG. 1, for example, a further driving trajectory 12 is shown. This may be a driving trajectory that is followed by another motor vehicle or external vehicle in shared traffic with the motor vehicle 1. As with the ego trajectory 10, the external trajectory 12 is again shown as a chain of points with a large number of data points 13.

To check whether there are several driving trajectories 10, 12 within the corridor boundaries 23, the driver assistance system 2 uses, for example, swarm data S from a so-called swarm intelligence. The swarm data S is data that has been collected or stored in a road book by a large number of motor vehicles that form a vehicle swarm or vehicle fleet with the motor vehicle 1. The swarm data S contains, for example, information on external vehicles that have also passed this section of the roadway 20 for the respective roadway section on which the vehicle is currently located. For example, the swarm data S may contain the driving trajectories of such external vehicles.

The roadbook with the swarm data S can, for example, be stored or saved on an external storage device, such as a backend server. In the present case, the external storage device is, for example, a cloud server 4 in a corresponding data memory. The motor vehicle 1, in particular the driver assistance system 2, can retrieve the swarm data S from the cloud server 4.

FIG. 2 will now be used as an example to explain a procedure for validating the travel corridor 22. FIG. 2 shows a schematic process flow diagram with individual process steps. The procedure shown in FIG. 2 can, for example, be carried out using the driver assistance system 2 of the motor vehicle 1.

In a step S10, the driving corridor 22 with its corridor boundaries 23 is first determined as a function of the environmental data U, in this case the sensor data provided by the camera 3. As described above, the corridor boundaries 23 specify the first track width S1 for the lateral guidance of the motor vehicle 1. As described above, the first track width S1 is used to calculate the ego trajectory 10 for the central guidance of the motor vehicle 1. The method is then continued in a step S20.

In step S20, the driver assistance system 2 checks whether more than one driving trajectory 10, 12 is provided within the corridor boundaries 23. For this purpose, the driver assistance system 2 records, for example, the swarm data S and evaluates it using suitable methods to determine whether the swarm data S contains the external trajectory 12. However, instead of evaluating the entire driving trajectory, i.e., all data points 11, 13, for the road section under consideration, only one data point 11a, 13a in particular is taken into account from the driving trajectories 10, 12. In this way, data processing resources, such as computing power, can be saved and the calculation can be performed particularly quickly. In particular, the lateral axis 5 of the motor vehicle 1 (the y-axis in the coordinate system) is taken into account as the basis for calculating the selection of the data points 11a, 13a. It is therefore determined whether there is one or more than one data point 11a, 13a along the rear axle 5 relative to its direction of travel F, each of which is assigned to a different driving trajectory 10, 12 and specifies geocoordinates of the assigned driving trajectory 10, 12.

In other words, at the height of the rear axle 5, each drivable path (driving trajectory 10, 12) is evaluated with only one point (data point 11a, 13a). In the coordinate system, the data points 11a and 13a therefore have an x value of 0 m. Instead, the two data points 11a, 13a only contain a y-value at the height of the rear axle 5 and can be provided with a corresponding sign. As a result, it is known that in the present embodiment examples two data points 11a, 13a are present in the travel corridor 22, and at what distance, for example, from the coordinate origin, i.e., from the data point 11a of the ego trajectory 10. Preferably, each data point 11a, 13a can also be assigned a direction specification for a direction of travel. This means that the data point 11a, 13a can also be used to determine whether the external vehicle is moving with or against the vehicle 1. The method is then continued in either step S30 or step S40.

If the check according to step S2 reveals that exactly one data point, for example the data point 11a of the ego trajectory 10, is present within the travel corridor 22 (N), the procedure is continued in step S30. In step S30, the travel corridor 22 is validated. The validation comprises using the first track width S1 specified by the corridor boundaries 23 for the lateral guidance of the motor vehicle 1. This means that the track width S1 is used as the basis for calculating the driving trajectory 10 according to the center guidance.

However, if the check in step S20 shows that more than one driving trajectory, in this case for example the ego trajectory 10 and the external trajectory 12, are present within the driving corridor 22 (Y), the procedure is continued in step S40. In step S40, the determined travel corridor 22 is falsified, i.e., rejected. The first track width S1 can therefore not be used for the center guidance to calculate the driving trajectory 10. Instead, the falsification involves defining a second track width S2 that is different from the first track width S1 and using it for the lateral guidance of the vehicle 1. This means that the center guidance is calculated based on the second track width S2. The lateral guidance is thus adjusted to the second track width S2. As shown in FIG. 1, the second track width S2 is narrower than the first track width S1.

The second lane width S2 is preferably adapted in such a way that the co-traffic or oncoming traffic can also use the travel corridor 22. This means that the associated lane for the motor vehicle 1 is shifted within the driving corridor 22. In a traffic system with right-hand traffic, the right-hand lane marking is used as a reference line or support line to define the second lane width S2, for example in the direction of travel F. This means that the right-hand corridor boundary 23 is used as the right-hand lane boundary. The left lane boundary is set depending on the determined lane width S2.

The dimensions of the respective track widths S1, S2 can, for example, be freely selectable, e.g., the track width values can be specified in accordance with a predetermined selection criterion as a function of a parameter of at least two driving trajectories within the driving corridor 22 or as a function of a parameter of the driving corridor 22. For example, the track width values can be stored as functions of the parameter in a characteristic map or a characteristic curve. The parameter may, for example, be a curvature of the travel corridor 22 or a distance between the data points 11a, 13a or a distance between the corridor boundaries 23.

In addition or alternatively, the track width value for the respective track width S1, S2 can be defined, for example, as a function of the direction of travel contained in the data points 11a, 13a relative to the direction of travel F of the motor vehicle 1. For example, a wider second track width S2 can be selected for the same direction of travel F (co-traffic) than for an opposite direction of travel (oncoming traffic).

FIG. 3 shows an example of an extended method according to FIG. 2, whereby a distance d between the data points 11a, 13a is taken into account for the calculation of the track width. FIG. 3 again shows a corresponding process flow diagram with individual process steps. The steps S10 to S30 in the process flow diagram according to FIG. 3 correspond to the steps S10 to S30 according to the process flow diagram in FIG. 2. If it is determined during the check according to step S20 that there are more than two driving trajectories 10, 12 within the driving corridor 22 (Y), the process is continued in a step S50 (instead of step S30). In step S50, the distance d of the data points 11a, 13a along the lateral axis is determined. For this purpose, for example, the y-value of the data point 13a is compared with the y-value of the data point 11a. In the present embodiment example, the data points can be 2.5 m apart, for example. The method is then continued in a step S60.

In a step S6, the second lane width, i.e., its lane width value, is determined or calculated as a function of the data point distance d. In the illustration according to FIG. 1, the lane for the motor vehicle 1 is shifted to the right, for example along the y-axis within the corridor boundaries 23, so that, for example, depending on the vehicle dimensions, there is then enough space within the driving corridor 22 for the motor vehicle 1 and any other vehicle that may appear. This of course also shifts the driving trajectory 10 for the motor vehicle 1, which should relate to the route guidance according to the second track width S2, to the right.

It is particularly advantageous that only those data points 13a of external trajectories are taken into account in the driving corridor validation that have the specified minimum distance to the data point 11a along the rear axle 5 of the motor vehicle 1. The minimum distance can, for example, be selected depending on the vehicle dimensions of the motor vehicle 1. For example, the minimum distance can be 1 m. Consideration of the minimum distance is useful because it may happen that the driving trajectories 10, 12 of different motor vehicles moving within the same driving corridor 22 may differ slightly without the motor vehicles moving in co-traffic or oncoming traffic. This can happen, for example, due to environmental conditions, for example road damage such as potholes in the roadway or depending on the driving style or a set driving mode and other driving settings of the motor vehicle 1. The one or more additional driving trajectories 12 are therefore only taken into account if the respective driving trajectory has been determined or identified as being co-traffic or oncoming traffic to the motor vehicle 1.

Overall, the embodiments show a method for improving a lateral guidance function on the basis of an evaluation of swarm data S.

German patent application no. 10 2023 124 799.9 filed Sep. 14, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for validating a driving corridor for lateral guidance of a motor vehicle by a driver assistance system, the method comprising:
determining, based on environmental data corresponding to an environment of the motor vehicle, corridor boundaries of the driving corridor, wherein the corridor boundaries specify a first track width for the lateral guidance of the motor vehicle;
checking whether more than one driving trajectory is provided within the corridor boundaries, by determining whether a plurality of data points is located along a predetermined lateral axis of the motor vehicle relative to a direction of travel of the motor vehicle, wherein each of the data points is assigned to a different driving trajectory and indicates at least geocoordinates of the different driving trajectory; and
validating, based on a result of the checking, the driving corridor by using the first track width specified by the corridor boundaries for the lateral guidance of the motor vehicle.

2. The method according to claim 1, wherein the driving corridor is only validated if exactly one data point within the driving corridor is determined according to the checking.

3. The method according to claim 1, further comprising:
falsifying the driving corridor based on a result of the checking when at least two data points within the driving corridor are determined according to the determining, wherein the falsifying includes determining a second track width different from the first track width and using the second track width for the lateral guidance of the motor vehicle.

4. The method according to claim 3, further comprising:
determining a data point spacing of the at least two data points along the predetermined lateral axis; and
determining the second track width based on the data point spacing.

5. The method according to claim 3, wherein the second track width is narrower than the first track width.

6. The method according to claim 3, wherein a value of the first track width and/or the second track width is selected according to a predetermined selection criterion as a function of a parameter of at least two travel trajectories within the driving corridor or as a function of a parameter of the driving corridor.

7. The method according to claim 3, wherein each of the data points contains information for an authorized driving direction along the different driving trajectory and the method further includes determining the second track width based on the authorized driving direction relative to a driving direction of the motor vehicle.

8. The method according to claim 1, further comprising:
determining the driving trajectory or an additional driving trajectory of the motor vehicle from swarm data, wherein the swarm data include an external trajectory of at least one external vehicle that has already passed through the driving corridor.

9. A driver assistance system for lateral guidance of a motor vehicle, the driver assistance system comprising:
at least one processor; and
at least one memory storing program code that, when executed by the at least one processor, causes the driver assistance system to:
determine, based on environmental data corresponding to an environment of the motor vehicle, corridor boundaries of a driving corridor, wherein the corridor boundaries specify a first track width for the lateral guidance of the motor vehicle;
check whether more than one driving trajectory is provided within the corridor boundaries, by determining whether a plurality of data points is located along a predetermined lateral axis of the motor vehicle relative to a direction of travel of the motor vehicle, wherein each of the data points is assigned to a different driving trajectory and indicates at least geocoordinates of the different driving trajectory; and
validate, based on a result of the check, the driving corridor by using the first track width specified by the corridor boundaries for the lateral guidance of the motor vehicle.

10. A motor vehicle including the driver assistance system according to claim 9.
